(19) United States
(12) Patent Application Publication
(10) Pub. No.: US 2014/0047324 A1
(43) Pub. Date: Feb. 13, 2014

(54) IMAGE FORMING DEVICE, WEB PAGE OBTAINING METHOD AND A NON-TRANSITORY COMPUTER-READABLE RECORDING MEDIUM ENCODED WITH WEB PAGE OBTAINING PROGRAM

(71) Applicant: Konica Minolta, Inc., Chiyoda-ku (JP)

(72) Inventor: Haruna SASAKUMA, Toyonaka-shi (JP)

(73) Assignee: Konica Minolta, Inc., Chiyoda-ku (JP)

(21) Appl. No.: 13/955,783

(22) Filed: Jul. 31, 2013

(30) Foreign Application Priority Data
Aug. 10, 2012 (JP) 2012-178862

(51) Int. Cl. G06F 17/22

(52) U.S. Cl. CPC G06F 17/2247
USPC 715/234

(57) ABSTRACT

An image forming device includes a display portion to display an image, a request portion to transmit a page transmission request in order to request transmission of a page described in a markup language from a server, a rendering portion to interpret a page received from the server in response to the transmission of the page transmission request to generate a screen and to display the generated screen on the display portion, a state detection portion to detect a state of the device, and an agent selecting portion to select a type of user agent corresponding to the detected state from a first type of user agent and a second type of user agent, and the request portion includes a setting portion to set the selected user agent in the page transmission request.

This application is based on Japanese Patent Application No. 2012-178862 filed with Japan Patent Office on Aug. 10, 2012, the entire content of which is hereby incorporated by reference.

### BACKGROUND OF THE INVENTION

1. Field of the Invention

The present invention relates to an image forming device, a web page obtaining method, and a non-transitory computer-readable recording medium encoded with a web page obtaining program, and more specifically to an image forming device provided with a browsing function, a web page obtaining method executed in that image forming device, and a non-transitory computer-readable recording medium encoded with a web page obtaining program.

2. Description of the Related Art

In recent years, there is an image forming device such as a multi function peripheral (hereinafter referred to as an MFP) which has a browsing program installed and is provided with a browsing function to download a web page from a Web server and to display the web page. This browsing program defines a single user agent, and the command transmitted by the MFP to the Web server to request the download of a web page includes a user agent determined by the browsing program. The Web server refers to the user agent included in the command and transmits back a web page suited to that user agent. Consequently, there is a Web server that transmits a different web page depending on the user agent so that the web page may be displayed appropriately in the device receiving the web page. For instance, there is a Web server that transmits different web pages for a device such as a computer whose area of display is relatively broad and whose storage capacity of the work memory for display is relatively large and for a device such as a PDA (Personal Digital Assistant) whose area of display is relatively small and whose storage capacity of the work memory for display is relatively small.

Japanese Patent Laid-Open No. 2005-92838 describes a system in which, in order to absorb the differences in the languages used and the terminal environment between the users and to allow a wide-ranged sharing of information, information is registered on a WEB browser or from a mobile phone, thereby storing the data automatically translated into the supported languages of various countries in a database on a server, and when a viewing request for the registered information occurs, a page for viewing corresponding to the terminal environment of the viewer is transmitted back in the language data suited to the viewer, using a template selected in advance by the person who disclosed the information.

In a conventional system, however, there is a problem in that a user must register the information with the server from a WEB browser or from a mobile phone, which complicates the operation by the user.

On the other hand, it is possible to expand the function of an MFP by attaching an optional equipment according to the form of usage. For instance, there are cases where an operation panel serving as a user interface is changed from one having a small area of display to one having a large area of display, and there are cases where a non-volatile memory is changed from one having a small storage capacity to one having a large storage capacity. In addition, there are cases where the MFP is operated by remote control from a computer connected to a network or from a portable computer such as a PDA to execute a browsing function and the web page received from a Web server is displayed on the device at which the remote control operation originated.

Since the user agent is determined by the browsing program, however, the user agent is fixed to the one defined by the browsing program regardless of whether the function of the MFP has been expanded or not and regardless of the device being operated by remote control. As a result, there was a problem that, around the time when an optional equipment is attached to the MFP and the function is expanded, a web page corresponding to the function after the expansion could not be displayed. Moreover, there was also the problem that, even when the device at which the remote control operation originated is different, the same web page would be downloaded so that the web page suited to the device of the origin of the remote control operation could not be displayed.

### SUMMARY OF THE INVENTION

According to one aspect of the present invention, an image forming device includes a display portion to display an image, a request portion to transmit a page transmission request in order to request transmission of a page described in a markup language from a server, a rendering portion to interpret a page received from the server in response to the transmission of the page transmission request to generate a screen and to display the generated screen on the display portion, a state detection portion to detect a state of the device, and an agent selecting portion to select a user agent of a type corresponding to the state detected by the state detection portion from a first type of user agent and a second type of user agent, and the request portion includes a setting portion to set the selected user agent in the page transmission request.

According to another aspect of the present invention, a web page obtaining method executed in an image forming device provided with a display portion to display an image includes a requesting step to transmit a page transmission request in order to request transmission of a page described in a markup language from a server, a rendering step to interpret a page received from the server in response to the transmission of the page transmission request to generate a screen and to display the generated screen on the display portion, a state detecting step to detect a state of the device, and an agent selecting step to select a user agent of a type corresponding to the state detected in the state detecting step from a first type of user agent and a second type of user agent, and the requesting step includes a setting step to set the user agent selected to the page transmission request.

According to a still other aspect of the present invention, a non-transitory computer-readable recording medium is encoded with a web page obtaining program executed by a computer, wherein the web page obtaining program executed by the computer controlling an image forming device provided with a display portion to display an image causes the computer to execute a requesting step to transmit a page transmission request in order to request transmission of a page described in a markup language from a server, a rendering step to interpret a page received from the server in response to the transmission of the page transmission request to generate a screen and to display the generated screen on the display portion, a state detecting step to detect a state of the device, and an agent selecting step to select a user agent of a type corresponding to the state detected in the state detecting step from a first type of user agent and a second type of user agent, and the requesting step includes a setting step to set the selected user agent in the page transmission request.

The foregoing and other features, aspects, and advantages of the present invention will become more apparent from the following detailed description of the present invention when taken in conjunction with the accompanying drawings.

### BRIEF DESCRIPTION OF THE DRAWINGS

FIG. 1 is an overall schematic diagram of an image forming system according to one embodiment of the present invention.

FIG. 2 is a block diagram showing one example of a hardware arrangement of an MFP.

FIG. 3 is a block diagram showing one example of a hardware arrangement of a portable information device.

FIG. 4 is a diagram showing one example of a function of a CPU provided in the MFP.

FIG. 5 is a flow chart showing one example of the flow of a web page obtaining process.

FIG. 6 is a flow chart showing one example of the flow of a remote control operation process.

FIG. 7 is a diagram showing one example of a server correspondence table.

FIG. 8 is a diagram showing one example of a device correspondence table.

FIG. 9 is a diagram showing one example of a browser correspondence table.

### DESCRIPTION OF THE PREFERRED EMBODIMENTS

The embodiments of the present invention will be described below with reference to the drawings. In the following description, the same or corresponding parts are denoted by the same reference characters. Their names and function are also the same. Thus, the detailed description thereof will not be repeated.

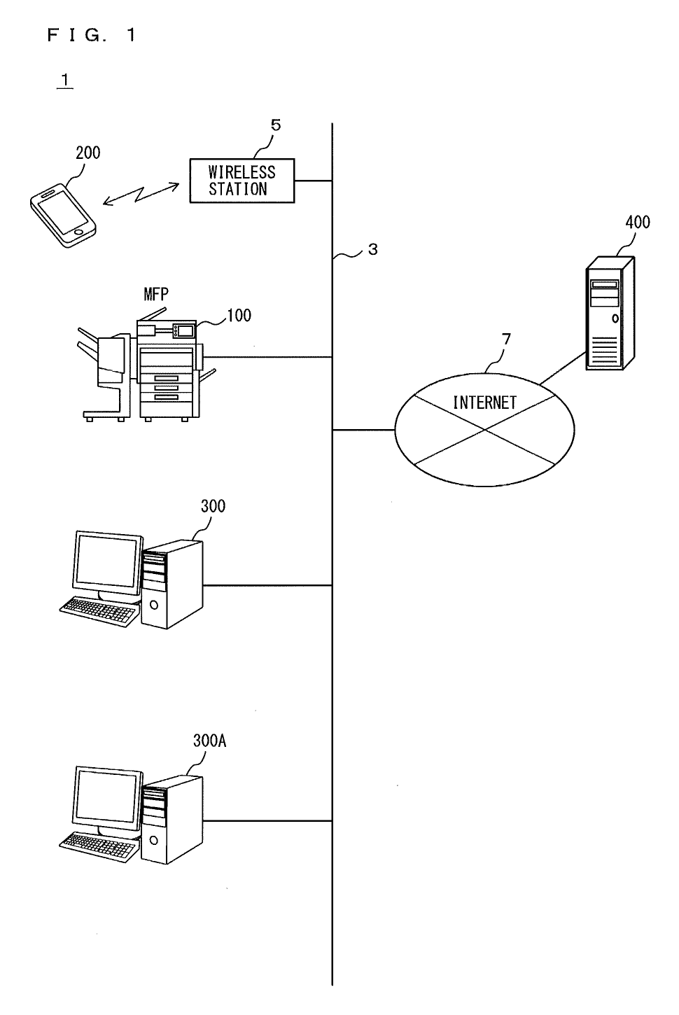

FIG. 1 is an overall schematic diagram of an image forming system according to one embodiment of the present invention. With reference to FIG. 1, an image forming system 1 includes a multi function peripheral (hereinafter referred to as an MFP) 100, a portable information device 200, personal computers (hereinafter referred to as “PCs”) 300 and 300A, and a wireless station 5, respectively connected to a network 3. Thus, MFP 100 is capable of communicating with PCs 300 and 300A and wireless station 5 via network 3.

Moreover, although the drawing shows the example in which one MFP (Multi Function Peripheral) 100 is connected as an example of the image forming device, the number of MFPs is not limited to this, and it may be one or more. In addition, instead of MFP 100, a computer, a facsimile machine, a printer, and the like may be used, for example, as long as it is a device provided with the function of processing an image.

Network 3 is a local area network (LAN) and the form of connection may be by cable or wireless. Moreover, network 3 is connected to the Internet 7. Consequently, MFP 100 is capable of communicating with a server 400 connected to Internet 7. Furthermore, network 3 is not limited to the LAN and may be a network using a wide area network (WAN), Public Switched Telephone Networks (PSTN) or the like.

Portable information device 200 is one example of an information processing device and is a PDA (Personal Digital Assistant) provided with a communication function such as electronic paper or a smart phone. Here, the case where portable information device 200 is a smart phone will be described as an example. Moreover, portable information device 200 is provided with a wireless LAN function. Portable information device 200 is connected to a mobile phone network by wireless communication with a base station for mobile phones and is capable of making a call.

Wireless station 5 is additionally connected to network 3. Wireless station 5 is a repeater device in network 3 and communicates with portable information device 200 having a wireless LAN communication function to connect portable information device 200 to network 3. Consequently, portable information device 200 is capable of transmitting data to and receiving data from MFP 100 and PCs 300 and 300A connected to network 3.

In image forming system 1 according to the present embodiment, MFP 100 communicates with one of portable information device 200, PCs 300 and 300A, and server 400 and transmits and receives data. The protocol for the data transmission and reception is not particularly limited and any protocol can be used.

Moreover, an application program for operating MFP 100 by remote control can be installed into each of portable information device 200 and PCs 300 and 300A. By having portable information device 200 and PCs 300 and 300A execute the application program, MFP 100 can be made to execute a variety of processes. The application program includes an application program for operating MFP 100 by remote control and includes a process to cause MFP 100 to form an image, a process to cause scanning of a sheet of an original document, a process in relation to data stored in MFP 100, and a browsing process to download a web page from server 400 and to display it. The processes of portable information device 200 and PCs 300 and 300A operating MFP 100 by remote control are all the same so that the case of portable information device 200 operating MFP 100 by remote control will be described as an example in the following description, unless mentioned otherwise.

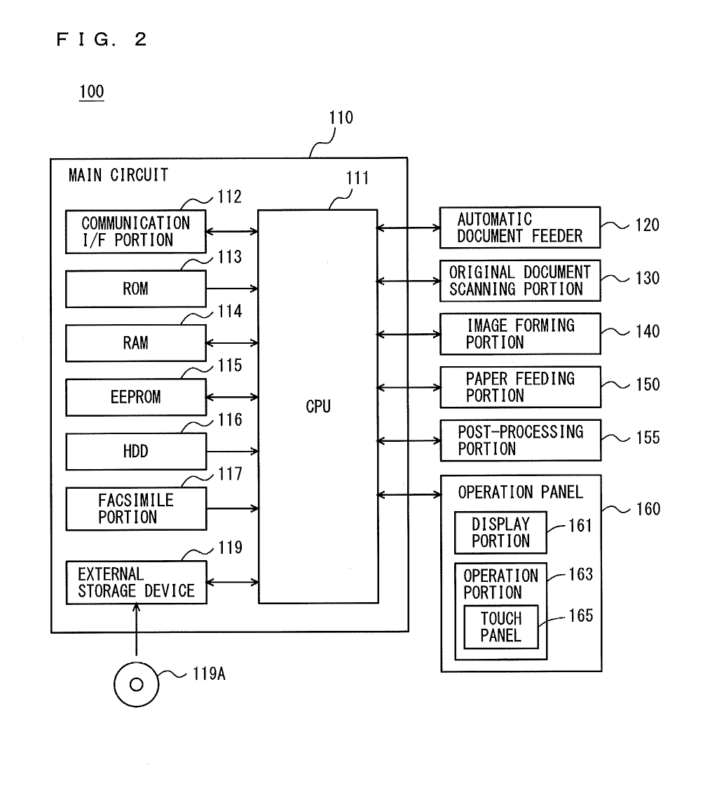

FIG. 2 is a block diagram showing one example of a hardware arrangement of an MFP. With reference to FIG. 2, MFP 100 includes a main circuit 110, an original document scanning portion 130 to scan a sheet of an original document, an automatic document feeder 120 to feed the sheet of the original document to original document scanning portion 130, an image forming portion 140 to form an image on a sheet of paper and the like based on image data outputted by original document scanning portion 130 after it scans the sheet of the original document, a paper feeding portion 150 to supply a sheet of paper to image forming portion 140, a post-processing portion 155, and an operation panel 160 serving as a user interface.

Main circuit 110 includes a CPU 111, a communication interface (I/F) portion 112, a ROM (Read Only Memory) 113, a RAM (Random Access Memory) 114, an EEPROM (Electrically Erasable and Programmable ROM) 115, a hard disk drive (HDD) 116 serving as a mass storage device, a facsimile portion 117, and an external storage device 119 onto which a CD-ROM (Compact Disk Read Only Memory) 119A is mounted. CPU 111 is connected to an automatic document feeder 120, original document scanning portion 130, image forming portion 140, paper feeding portion 150, post-processing portion 155, and operation panel 160 and controls the entire MFP 100.

ROM 113 stores a program to be executed by CPU 111 or the data necessary for execution of that program. RAM 114 is used as a work area when CPU 111 executes a program. In addition, RAM 114 temporarily stores the scanned data (image data) sent continuously from original document scanning portion 130.

Operation panel 160 is provided on a top surface of MFP 100. Operation panel 160 includes a display portion 161 and an operation portion 163. Display portion 161 is a display device such as a liquid crystal display (LCD) and an organic ELD (Electro-Luminescence Display), and displays an instruction menu for a user, information related to the image data obtained, and the like. Operation portion 163 is provided with a plurality of keys and accepts the input of data such as a number, a character, and a variety of instructions given by user operation corresponding to the keys. Operation portion 163 further includes a touch panel 165 which detects a position instructed by the user at a display surface of display portion 161. Touch panel 165 is provided on a top surface or a bottom surface of display portion 161 and outputs to CPU 111 the coordinates of the position instructed by the user.

An automatic document feeder 120 automatically conveys a plurality of sheets of original document being set on an original document paper feed tray one sheet at a time to a prescribed original document scanning position set on a platen glass of original document scanning portion 130, and discharges the sheet of original document onto an original document paper discharge tray after the original document image has been scanned by original document scanning portion 130. Original document scanning portion 130 includes a light source for irradiating light on the sheet of original document conveyed to the original document scanning position and a photoelectric transducer for receiving the light reflected from the sheet of original document, and scans an original document image corresponding to the size of the sheet of original document. The photoelectric transducer converts the received light into image data as an electrical signal and outputs it to image forming portion 140. Paper feeding portion 150 conveys a sheet of paper stored in the paper feed tray to image forming portion 140.

Image forming portion 140 forms an image by a well-known electrophotographic method, and forms the image on the sheet of paper conveyed by paper feeding portion 150 based on image data after data processing obtained by applying a variety of data processing such as shading correction to the image data inputted from original document scanning portion 130 or based on image data received from outside and discharges the sheet of paper with the image formed thereon to post-processing portion 155.

Post-processing portion 155 is provided with a plurality of bins for accumulating the sheets of paper and executes post-processing on one or more sheets of paper conveyed from image forming portion 140. The post-processing includes a sorting process to sort one or more sheets of paper into a plurality of sets by conveying the sheets of paper to a plurality of bins in sequence, a punching process to apply a punch hole process to a sheet of paper, and a staple process to knock a staple into a sheet of paper. In addition, the post-processing is not limited to these and may include other processes as long as they involve conveying or processing one or more sheets of paper.

Communication I/F portion 112 is an interface for connecting MFP 100 to network 3. CPU 111 communicates with PCs 300 and 300A connected to network 3 via communication I/F portion 112, with portable information device 200 connected via wireless station 5, and with server 400 connected to Internet 7 to transmit and receive data.

Facsimile portion 117 is connected to a Public Switched Telephone Networks (PSTN) and transmits and receives facsimile data. Facsimile portion 117 converts the image data scanned by original document scanning portion 130 or the data stored in HDD 116 into facsimile data and transmits the converted data to a facsimile device connected to the PSTN. Moreover, facsimile portion 117 stores the received facsimile data in HDD 116 or causes image forming portion 140 to form an image of the facsimile data onto a sheet of paper.

External storage device 119 has CD-ROM 119A mounted thereto. CPU 111 is capable of accessing CD-ROM 119A via external storage device 119. CPU 111 loads a program stored in CD-ROM 119A mounted on external storage device 119 into RAM 114 and executes it. Moreover, the program to be executed by CPU 111 is not limited to the program stored in CD-ROM 119A, and a program stored in HDD 116 may be loaded into RAM 114 and be executed. In this case, another computer connected to the network may rewrite the program stored in HDD 116 of MFP 100 or it may additionally write in a new program. Moreover, MFP 100 may download a program from another computer connected to the network and store this program in HDD 116. The program referred to here includes not only a program directly executable by CPU 111 but also a source program, a compressed program, an encrypted program, and the like.

There are cases where the hardware arrangement of MFP 100 is altered by replacing a part of the existing hardware equipment with an optional equipment or by attaching an optional equipment. The addition of an optional equipment to MFP 100 expands the function of MFP 100.

There are cases, for example, where operation panel 160 is replaced by a different operation panel which is an optional equipment. The different operation panel which is an optional equipment has a display surface having a larger area of display or a higher resolution than the display surface of display portion 161. Consequently, if the area of display of the display portion of the operation panel of the optional equipment is large, the screen can be displayed in a large size, and if the resolution of the display portion of the operation panel of the optional equipment is high, the screen can be displayed with sharpness. As a result, after the attachment of the operation panel of the optional equipment, even when a screen of a size which is larger in comparison to that before the attachment is displayed, the image or characters and the like within the displayed screen can be displayed in a manner viewable by a user.

In addition, there is a case where RAM 114 is replaced by a RAM which is an optional equipment having a larger storage capacity than RAM 114. In this case, the memory area to be used as a work area by CPU 111 becomes larger. Moreover, there is a case where a RAM as an optional equipment is attached in addition to RAM 114. In this case, also, the memory area to be used as the work area by CPU 111 becomes larger. When the memory area used as the work area by CPU 111 becomes larger, the processing speed of CPU 111 can be increased. In particular, the speed of processing an image as in the process of generating a screen to be displayed on display portion 161, the sharpening processing, and the like is increased so that a larger screen or a screen having a large amount of data such as an image can be displayed.

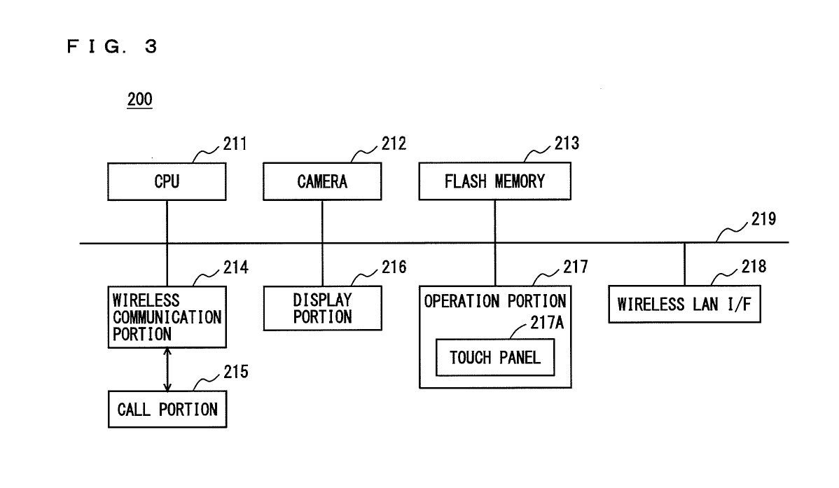

FIG. 3 is a block diagram showing one example of a hardware arrangement of a portable information device. With reference to FIG. 3, a portable information device 200 includes a CPU 211 for controlling the entire portable information device 200, a camera 212, a flash memory 213 to store data in a non-volatile manner, a call portion 215, a wireless communication portion 214 being connected to call portion 215, a display portion 216 to display information, an operation portion 217 to accept the input of an operation by a user, and a wireless LAN interface (I/F) 218.

Wireless communication portion 214 communicates by wireless with a base station for mobile phones connected to a telephone communication network. Wireless communication portion 214 connects portable information device 200 to the telephone communication network and allows calling using call portion 215. Wireless communication portion 214 decodes the audio signal derived by demodulating the radio signal received from the base station for mobile phones and outputs the decoded signal to call portion 215. In addition, wireless communication portion 214 encodes the voice inputted from call portion 215 and transmits the encoded voice to the base station for mobile phones. Call portion 215 is provided with a microphone and a speaker, and outputs the voice inputted from wireless communication portion 214 from the speaker and outputs the voice inputted from the microphone to wireless communication portion 214. Further, wireless communication portion 214 is controlled by CPU 211, transmits and receives data via the base station for mobile phones, and connects portable information device 200, for instance, to the Internet.

Camera 212 is provided with a photoelectric transducer such as a CMOS (Complementary Metal Oxide Semiconductor) sensor and a lens, and the light focused by the lens forms an image in the CMOS sensor and the CMOS sensor causes the received light to undergo a photoelectric transfer and outputs image data to CPU 211.

Display portion 216 is a display device such as a liquid crystal display (LCD) and an organic ELD, and displays an instruction menu for a user, data received from outside and so on. Operation portion 217 is provided with a plurality of keys and accepts the input of data such as a number, a character, and a variety of instructions given by user operation corresponding to the keys.

In addition, operation portion 217 includes a touch panel 217A. Touch panel 217A detects a position instructed by the user within the display surface of display portion 216. Touch panel 217A is provided on a top surface or a bottom surface of display portion 216 and outputs to CPU 211 the coordinates of the position instructed by the user. Touch panel 217A is a multi-touch screen panel and, when a plurality of positions are instructed by the user simultaneously, it outputs to CPU 211 a plurality of sets of coordinates respectively corresponding to the plurality of positions instructed by the user. It is preferable that touch panel 217A is of a size equal to or greater than that of the display surface of display portion 216. Touch panel 217A is provided overlapping display portion 216 so that, when the user instructs on the display surface of display portion 216, touch panel 217A outputs to CPU 211 one or more sets of coordinates respectively corresponding to one or more positions instructed by the user within the display surface of display portion 216. As touch panel 217A, a resistive film type, a surface acoustic wave type, an infrared type, an electromagnetic induction type, and a capacitive type may be used, and the type is not limited.

Wireless LAN I/F 218 is an interface for communicating with wireless station 5 to connect portable information device 200 to network 3. Portable information device 200 is capable of communicating with MFP 100, PCs 300 and 300A, and server 400 via wireless LAN I/F 218 and is capable of transmitting and receiving data.

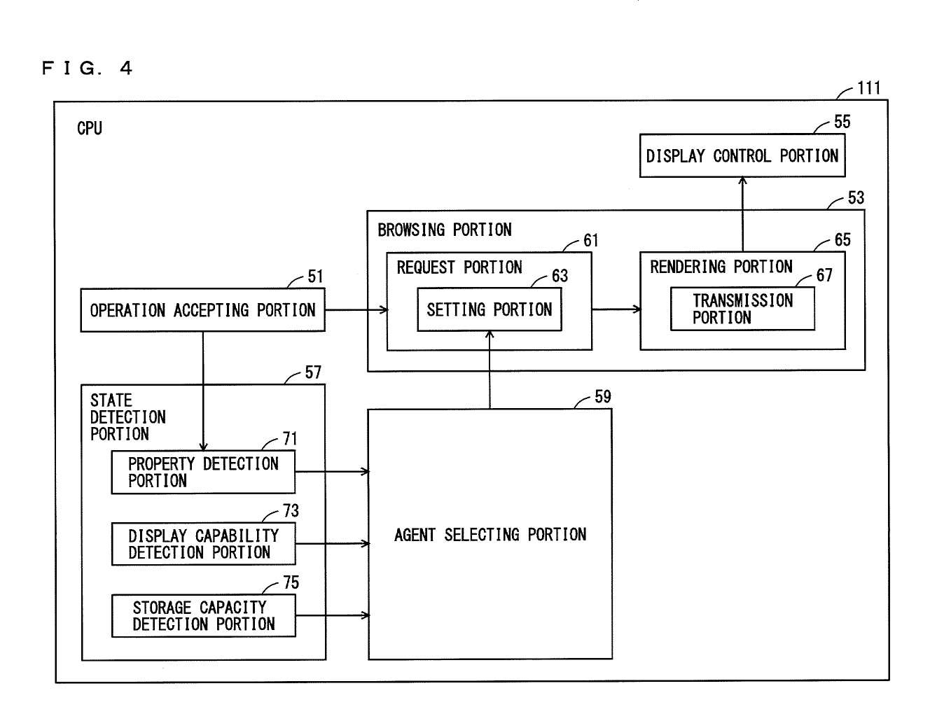

FIG. 4 is a diagram showing one example of a function of a CPU provided in the MFP. The function shown in FIG. 4 is the function formed in CPU 111 when CPU 111 provided in MFP 100 executes a web page obtaining program stored in ROM 113, EEPROM 115, HDD 116, or CD-ROM 119A. With reference to FIG. 4, CPU 111 includes an operation accepting portion 51 to accept an operation inputted by a user, a browsing portion 53, a display control portion 55 to control display portion 161, a state detection portion 57, and an agent selecting portion 59.

Operation accepting portion 51 accepts an operation inputted into operation portion 163 by a user and outputs the accepted operation and device identification information for identifying that operation portion 163, as a set, to browsing portion 53. Moreover, when the user operates portable information device 200 and PCs 300 and 300A to operate MFP 100 by remote control, the remote control operation received from one of portable information device 200 and PCs 300 and 300A by communication I/F portion 112 is accepted, and the accepted remote control operation and the device identification information for identifying the device that has transmitted that remote control operation are outputted as a set to browsing portion 53. The device identification information is any information that can specify the device, and it may, for instance, be a network address given on network 3, or it may be a name given to the device. Here, the device identification information of operation portion 163 is to be an IP (Internet Protocol) address which is the network address assigned to MFP 100, and the device identification information of portable information device 200 and PCs 300 and 300A are to be the IP addresses respectively assigned to them.

For instance, in the case where the user operates operation portion 163 to operate MFP 100, operation accepting portion 51 accepts the operation inputted into operation portion 163 and outputs the set of the accepted operation and the device identification information of MFP 100 to browsing portion 53. Moreover, in the case where the user operates portable information device 200 to operate MFP 100 by remote control, an application program for remote control operation is executed in portable information device 200, and when the user inputs the remote control operation into portable information device 200, portable information device 200 transmits the remote control operation via wireless LAN I/F 218 to MFP 100. When communication I/F portion 112 receives the remote control operation from portable information device 200, operation accepting portion 51 accepts that remote control operation and outputs the set of the accepted remote control operation and the device identification information of portable information device 200 to browsing portion 53. Furthermore, in the case where the user operates PCs 300 and 300A to operate MFP 100 by remote control, the application program for remote control operation is executed in PCs 300 and 300A, and when the user inputs the remote control operation into PCs 300 and 300A, PCs 300 and 300A transmit the remote control operation via wireless LAN I/F 218 to MFP 100. When communication I/F portion 112 receives the remote control operation from one of PCs 300 and 300A, operation accepting portion 51 accepts that remote control operation and outputs to browsing portion 53 the set of the accepted remote control operation and the device identification information of one device of PCs 300 and 300A that has transmitted the remote control operation.

In addition, when accepting the remote control operation from one of portable information device 200 and PCs 300 and 300A, operation accepting portion 51 outputs to state detection portion 57 the device identification information for identifying the one device among portable information device 200 and PCs 300 and 300A that has transmitted the remote control operation.

State detection portion 57 detects the state of the hardware arrangement of MFP 100. Moreover, when MFP 100 is operated by remote control, state detection portion 57 detects the state of the device of the origin of the remote control operation. State detection portion 57 includes a property detection portion 71, a display capability detection portion 73, and a storage capacity detection portion 75.

Property detection portion 71 detects a property of the device specified by device identification information in response to the input of the device identification information from operation accepting portion 51. Property detection portion 71 outputs the detected property to agent selecting portion 59. The properties include a high function screen and a low function screen. The property of the high function screen is a higher display capability and a larger storage capacity in comparison with the property of the low function screen. The display capability is the size of the screen and the resolution. The display capability may be one of the size of the screen and the resolution. A device having the property of the high function screen is a personal computer and the like. A device having the property of the low function screen is a portable information device such as a mobile phone and a PDA.

More specifically, property detection portion 71 distinguishes the property based on the type and the version of the operating system being installed in the device specified by the device identification information. In this case, property detection portion 71 makes an inquiry to the device specified by the device identification information via communication I/F portion 112 in order to obtain the type and the version of the operating system and decides the property based on the type and the version of the operating system obtained. This is so because the types and the versions of the operating systems respectively installed in a personal computer and in a portable information device differ. Moreover, in the case where a browsing program is installed in the device specified by the device identification information, property detection portion 71 may make an inquiry via communication I/F portion 112 to the device that has transmitted the remote control operation so as to obtain the type and the version of the browsing program and may decide the property based on the type and the version of the browsing program. This is so because the types and the versions of the browsing programs respectively installed in a personal computer and in a portable information device differ.

Display capability detection portion 73 detects the display capability of display portion 161. The display capability of display portion 161 of operation panel 160 includes the size of the display surface and the resolution. The display capability may be one of the size of the display surface and the resolution. The display capability of display portion 161 of operation panel 160 is stored in EEPROM 115 upon shipping of MFP 100. In addition, in the case where operation panel 160 is replaced by an optional equipment, the display capability stored in EEPROM 115 is rewritten by the display capability of a display portion provided in an operation panel of the optional equipment upon replacement. Thus, display capability detection portion 73 detects the display capability of display portion 161 by reading the display capability stored in EEPROM 115. Display capability detection portion 73 outputs the detected display capability to agent selecting portion 59. Moreover, in the case where operation panel 160 has a memory such as a ROM that stores the display capability of display portion 161, display capability detection portion 73 may be made to read the display capability from that memory.

Storage capacity detection portion 75 detects the storage capacity of RAM 114. The storage capacity is the storage capacity of the portion excluding the portion being used as a work area by CPU 111 in RAM 114. Moreover, in the case where RAM 114 has been replaced by a RAM of an optional equipment, storage capacity detection portion 75 detects the storage capacity of the RAM after the replacement. Furthermore, in the case where a RAM of an optional equipment is provided in addition to RAM 114, the sum total of the respective storage capacities of RAM 114 and the additionally provided RAM is detected. Storage capacity detection portion 75 outputs the detected storage capacity to agent selecting portion 59.

To agent selecting portion 59, a property is inputted from property detection portion 71, a display capability is inputted from display capability detection portion 73, and a storage capacity is inputted from storage capacity detection portion 75. Agent selecting portion 59 stores a first type of user agent and a second type of user agent in advance, selects one of the first type of user agent and the second type of user agent based on the property, the display capability, and the storage capacity, and outputs the selected type of user agent to browsing portion 53. The first type of user agent is one of a plurality of user agents determined by the set of the type and the version of the operating system installed in a personal computer and the like, and the second type of user agent is one of a plurality of user agents determined by the set of the type and the version of the operating system installed in a portable information device such as a mobile phone and a PDA, and one is predetermined for each in MFP 100.

In comparison with a portable information device, a personal computer has a display with a large display surface for displaying a web page. As a result, there are cases where the web page transmitted back by server 400 receiving a GET command including the first type of user agent differs from the web page transmitted back by server 400 receiving a GET command including the second type of user agent. Hereinafter, the web page which server 400 transmits back in response to the GET command including the first type of user agent is referred to as a first type of web page, and the web page which server 400 transmits back in response to the GET command including the second type of user agent is referred to as a second type of web page. There are cases where the first type of web page is larger in size than the second type of web page and also has a larger amount of data.

When a property is inputted from property detection portion 71, agent selecting portion 59 selects one type of user agent from the first type of user agent and the second type of user agent according to the property, regardless of the display capability inputted from display capability detection portion 73 and the storage capacity inputted from storage capacity detection portion 75. More specifically, agent selecting portion 59 selects the first type of user agent when the property inputted from property detection portion 71 indicates a high function screen which is the property of a personal computer and selects the second type of user agent when the property inputted from property detection portion 71 indicates a low function screen which is the property of a portable information device. Agent selecting portion 59 outputs the selected user agent to browsing portion 53.

If no property is inputted from property detection portion 71, in other words, when a user operates operation panel 160, agent selecting portion 59 selects one type of user agent from the first type of user agent and the second type of user agent according to the display capability inputted from display capability detection portion 73 and/or the storage capacity inputted from storage capacity detection portion 75.

More specifically, in the case where the display capability is inputted from display capability detection portion 73, agent selecting portion 59 selects the first type of user agent provided that the display capability is a first threshold value TH1 or greater, and selects the second type of user agent if the display capability is less than first threshold value TH1.

First threshold value TH1 includes a threshold value TH11 corresponding to the size of the screen and a threshold value TH12 corresponding to the resolution. In the case where the size of the screen is used and the resolution is not used as the display capability, of first threshold value TH1, threshold value TH11 corresponding to the size of the screen alone is used, and if the size of the screen of the display capability is threshold value TH11 or greater, the display capability is determined to be equal to or greater than first threshold value TH1 regardless of the resolution of the display capability. Moreover, in the case where the resolution is used and the size of the screen is not used as the display capability, of first threshold value TH1, threshold value TH12 corresponding to the resolution alone is used, and if the resolution is threshold value TH12 or greater, the display capability is determined to be equal to or greater than first threshold value TH1 regardless of the size of the screen of the display capability. Furthermore, in the case where the size of the screen and the resolution are used as the display capability, threshold value TH11 corresponding to the size of the screen and threshold value TH12 corresponding to the resolution of first threshold value TH1 are used, and if the size of the screen of the display capability is threshold value TH11 or greater and if the resolution is threshold value TH12 or greater, the display capability is determined to be equal to or greater than first threshold value TH1. In this case, if the size of the screen of the display capability is less than threshold value TH11 or if the resolution is less than threshold value TH12, the display capability is determined to be less than first threshold value TH1.

In the case where no property is inputted from property detection portion 71 and the storage capacity is inputted from storage capacity detection portion 75, agent selecting portion 59 selects the first type of user agent provided that the storage capacity is a second threshold value TH2 or greater, and selects the second type of user agent if the storage capacity is less than second threshold value TH2. The storage capacity inputted from storage capacity detection portion 75 is the storage capacity that can be used as a work area by CPU 111, and is, in other words, a free space where data can be stored. For instance, even when the capacity which RAM 114 is capable of storing is second threshold value TH2 or greater, if the load of CPU 111 is great and the area used in RAM 114 is large, there may be cases where the free space of RAM 114 becomes less than second threshold value TH2. Thus, the storage capacity inputted from storage capacity detection portion 75 is to be the storage capacity that can be used as a work area by CPU 111 so that the user agent can be selected according to the circumstance in which CPU 111 uses RAM 114.

Furthermore, in the case where no property is inputted from property detection portion 71 and where the display capability is inputted from display capability detection portion 73 and the storage capacity is inputted from storage capacity detection portion 75, agent selecting portion 59 selects the first type of user agent provided that the display capability is first threshold value TH1 or greater and that the storage capacity is second threshold value TH2 or greater, and selects the second type of user agent if the display capability is less than first threshold value TH1 or if the storage capacity is less than second threshold value TH2.

The operation that operation accepting portion 51 accepts from operation portion 163 and the remote control operation received from one of portable information device 200 and PCs 300 and 300A include a page transmission request operation which is the operation of requesting for the transmission of a web page stored in a Web server connected to Internet 7. The page transmission request operation includes a URL (Uniform Resource Locator) assigned to the web page whose transmission is requested.

When a set of the page transmission request operation and device identification information is inputted from operation accepting portion 51, browsing portion 53 transmits a page transmission request command to a Web server connected to Internet 7 to request for the transmission of the web page, receives the web page transmitted back from the Web server, and outputs it. Here, the case where the page transmission request operation inputted from operation accepting portion 51 includes a URL assigned to the web page stored in server 400 is described as an example.

Browsing portion 53 includes a request portion 61 and a rendering portion 65. To request portion 61, a user agent is inputted from agent selecting portion 59 and the set of the page transmission request operation and the device identification information is inputted from operation accepting portion 51. In response to the page transmission request operation being inputted from operation accepting portion 51, request portion 61 generates a page transmission request command, for instance, a GET command, which includes the URL included in the page transmission request operation and which requests for the transmission of a web page. Upon generating the page transmission request command, request portion 61 transmits the generated page transmission request command via communication I/F portion 112 to server 400 specified by the URL included in the page transmission request operation as well as outputs the set of the page transmission request command and the device identification information to rendering portion 65.

Request portion 61 includes a setting portion 63. To setting portion 63, a user agent is inputted from agent selecting portion 59. Setting portion 63 sets the user agent inputted from agent selecting portion 59 to a header of the page transmission request command for requesting the transmission of the web page.

After the set of the page transmission request command and the device identification information is inputted from request portion 61, when communication I/F portion 112 receives the web page from server 400, rendering portion 65 obtains the received web page. Thereafter, rendering portion 65 interprets the obtained web page to generate a screen, and outputs the generated screen to display control portion 55. Display control portion 55 controls display portion 161 and causes display portion 161 to display the screen inputted from browsing portion 53.

Rendering portion 65 includes a transmission portion 67. When the device identification information inputted from request portion 61 is different from that of MFP 100, transmission portion 67 transmits the generated screen to the device specified by the device identification information via communication I/F portion 112.

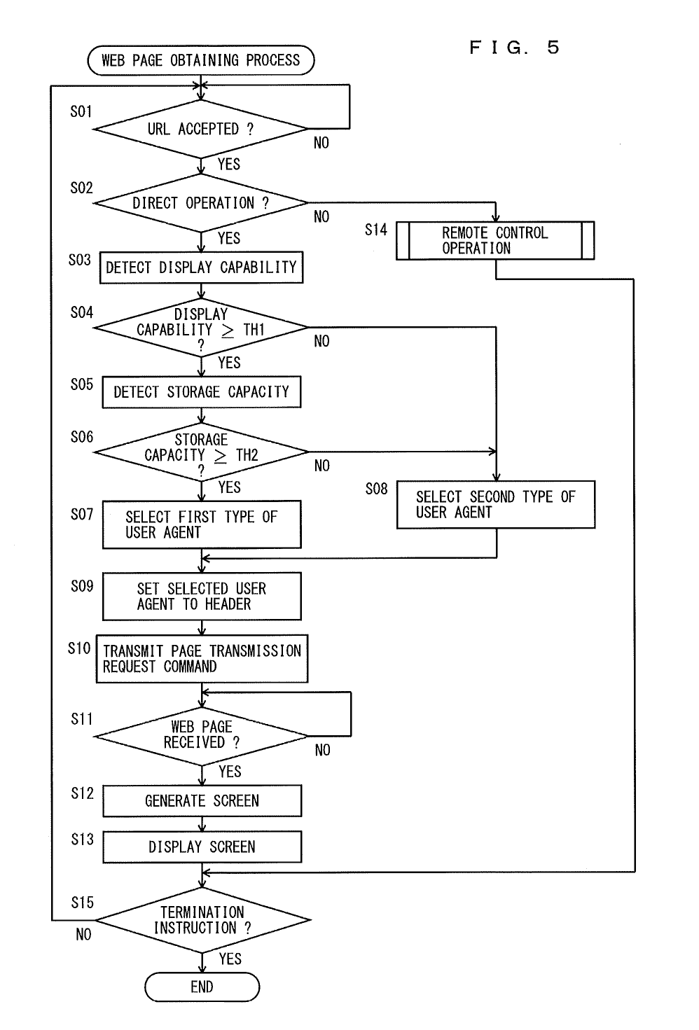

FIG. 5 is a flow chart showing one example of the flow of a web page obtaining process. The web page obtaining process is a process executed by CPU 111 when CPU 111 provided in MFP 100 executes a web page obtaining program stored in ROM 113, EEPROM 115, HDD 116, or CD-ROM 119A. With reference to FIG. 5, CPU 111 determines whether a URL has been accepted or not (step S01). When operation portion 163 detects an operation by a user inputting a URL, the detected URL is accepted. Moreover, when communication I/F portion 112 receives a remote control operation including a URL from one of portable information device 200 and PCs 300 and 300A, the URL included in the received remote control operation is accepted. The process stands by until the URL is accepted (NO in step S01), and if the URL is accepted (YES in step S01), the process proceeds to a step S02.

In step S02, it is determined whether the operation is direct or not. If the URL was accepted from operation portion 163 in step S01, it is determined to be a direct operation, but if the URL was accepted from communication I/F portion 112, the process proceeds to a step S14. In step S14, a remote control operation process is executed, and the process proceeds to a step S15. The details of the remote control operation process will be described later.

In a step S03, a display capability is detected. More specifically, the display capability of display portion 161 stored in EEPROM 115 is read. In the case where operation panel 160 is replaced by an optional equipment, the display capability of the display portion provided in the operation panel of the optional equipment is stored in EEPROM 115 so that this display capability would be read. In addition, in the case where operation panel 160 has a memory such as a ROM for storing the display capability of display portion 161, the display capability is read from that memory.

In the next step S04, it is determined whether or not the display capability is first threshold value TH1 or greater. If the display capability is first threshold value TH1 or greater, the process proceeds to a step S05, but if not, the process proceeds to a step S08. The display capability includes the size of the screen and the resolution. First threshold value TH1 may be a value corresponding to the size of the screen alone or it may be a value corresponding to the resolution alone, or it may be a value corresponding to the combination of the size and the resolution.

First threshold value TH1 includes threshold value TH11 corresponding to the size of the screen and threshold value TH12 corresponding to the resolution. In the case where the size of the screen is used and the resolution is not used as the display capability, of first threshold value TH1, threshold value TH11 corresponding to the size of the screen alone is used, and if the size of the screen of the display capability is threshold value TH11 or greater, the display capability is determined to be equal to or greater than first threshold value TH1, and if the size of the screen of the display capability is less than threshold value TH11, the display capability is determined to be less than first threshold value TH1, regardless of the resolution of the display capability. Moreover, in the case where the resolution is used and the size of the screen is not used as the display capability, of first threshold value TH1, threshold value TH12 corresponding to the resolution alone is used, and if the resolution is threshold value TH12 or greater, the display capability is determined to be equal to or greater than first threshold value TH1, and if the resolution is less than threshold value TH12, the display capability is determined to be less than first threshold value TH1, regardless of the size of the screen of the display capability. Furthermore, in the case where the size of the screen and the resolution are used as the display capability, threshold value TH11 corresponding to the size of the screen and threshold value TH12 corresponding to the resolution of first threshold value TH1 are used, and if the size of the screen of the display capability is threshold value TH11 or greater and if the resolution is threshold value TH12 or greater, the display capability is determined to be equal to or greater than first threshold value TH1, and if the size of the screen of the display capability is less than threshold value TH11 or if the resolution is less than threshold value TH12, the display capability is determined to be less than first threshold value TH1.

In step S05, a storage capacity is detected. More specifically, the storage capacity of the portion excluding the portion being used as a work area by CPU 111 in RAM 114 is detected. Moreover, in the case where RAM 114 has been replaced by a RAM of an optional equipment, the storage capacity of the RAM after the replacement is detected. Furthermore, in the case where a RAM of an optional equipment is provided in addition to RAM 114, the sum total of the respective storage capacities of RAM 114 and the additionally provided RAM is detected.

In the next step S06, it is determined whether or not the detected storage capacity is second threshold value TH2 or greater. If the storage capacity is second threshold value TH2 or greater, the process proceeds to a step S07, but if not, the process proceeds to a step S08.

In step S07, a first type of user agent is selected and the process proceeds to a step S09. On the other hand, in step S08, a second type of user agent is selected, and the process proceeds to step S09.

In step S09, the first type or the second type of user agent selected in either step S07 or step S08 is set to a header portion of a page transmission request command, and the process proceeds to a step S10.

In step S10, the page transmission request command is transmitted in which the URL accepted in step S01 is set. The page transmission request command is a GET command, for instance, and the GET command is transmitted via communication I/F portion 112 to a computer specified by the URL, or here, to server 400.

In the next step S11, it is determined whether a web page has been received or not. It is determined whether or not communication I/F portion 112 has received the web page from the computer that transmitted the page transmission request command in step S10, or here, from server 400. The process stands by until a web page is received from server 400, and if the web page has been received, the process proceeds to a step S12.

In step S12, the web page received in step S11 is interpreted and a screen is generated. In the next step S13, the screen is displayed on display portion 161, and the process proceeds to a step S15. In step S15, it is determined whether a termination instruction has been accepted or not. If the termination instruction has been accepted, the process ends, but if not, the process returns to step S01. In the case where the URL had been accepted from operation portion 163 in step S01, the termination instruction is accepted when the user instructs on the key which is provided in operation portion 163 and to which the termination instruction is assigned in advance. In the case where the URL is accepted by communication I/F portion 112 receiving a remote control operation in step S01, the termination instruction is accepted when the received remote control operation indicates a termination instruction.

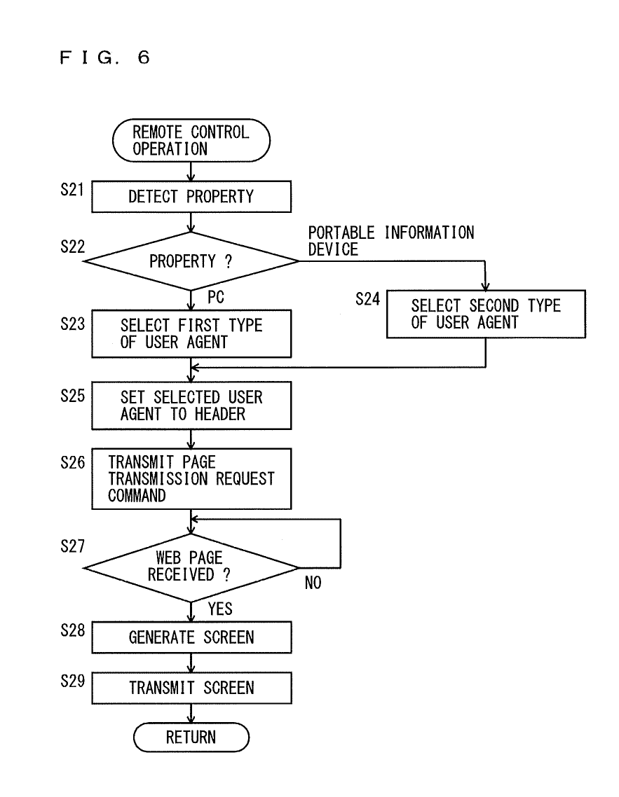

FIG. 6 is a flow chart showing one example of the flow of a remote control operation process. The remote control operation process is a process executed in step S14 of the web page obtaining process shown in FIG. 5. In a stage prior to the execution of the remote control operation process, in step S01, the remote control operation has been received in communication I/F portion 112 and the URL has been accepted. With reference to FIG. 6, CPU 111 detects the property of the device that has transmitted the remote control operation (step S21). The property includes a personal computer and a portable information device.

More specifically, the property is distinguished based on the type and the version of the operating system installed in the device that has transmitted the remote control operation among portable information device 200 and PCs 300 and 300A. In this case, an inquiry is made to the device that has transmitted the remote control operation via communication I/F portion 112, so as to obtain the type and the version of the operating system, and the property is decided based on the type and the version of the operating system obtained. This is so because the types and the versions of the operating systems respectively installed in a personal computer and in a portable information device differ. Moreover, in the case where a browsing program is installed in the device that has transmitted the remote control operation, an inquiry may be made to the device that has transmitted the remote control operation so as to obtain the type and the version of the browsing program, and the property may be decided based on the type and the version of the browsing program. This is so because the types and the versions of the browsing programs respectively installed in a personal computer and in a portable information device differ.

In the next step S22, the process diverges based on the detected property. If the property is the property of the personal computer, the process proceeds to a step S23, but if this is not so and the property is the property of the portable information device, the process proceeds to a step S24.

In step S23, a first type of user agent is selected, and the process proceeds to a step S25. On the other hand, in step S24, a second type of user agent is selected, and the process proceeds to step S25.

In step S25, the first type or the second type of user agent selected in step S23 or step S24 is set to a header portion of a page transmission request command, and the process proceeds to a step S26.

In step S26, the page transmission request command is transmitted in which the URL accepted in step S01 is set. The page transmission request command is a GET command, for instance. The GET command is transmitted via communication I/F portion 112 to a computer specified by the URL accepted in step S01, or here, to server 400.

In the next step S27, it is determined whether a web page has been received or not. It is determined whether or not communication I/F portion 112 has received the web page from the computer that transmitted the page transmission request command in step S26, or here, from server 400. The process stands by until a web page is received from server 400, and if the web page has been received, the process proceeds to a step S28.

In step S28, the web page received in step S27 is interpreted and a screen is generated. In the next step S29, the screen is transmitted via communication I/F portion 112 to the device that has transmitted the remote control operation received in step S01, and the process returns to the web page obtaining process.

[First Modification]

In MFP 100 in image forming system 1 described above, one of a plurality of first type of user agents determined by a set of the type and the version of the operating system installed in a personal computer and the like and one of a plurality of second type of user agents determined by a set of the type and the version of the operating system installed in a portable information device such as a mobile phone and a PDA are stored, and the first type of user agent is selected when the device that has transmitted the remote control operation is PCs 300 and 300A, while the second type of user agent is selected when the device that has transmitted the remote control operation is portable information device 200.

In a MFP 100A according to the first modification, a plurality of the first type of user agents and a plurality of the second type of user agents are stored and a user agent corresponding to a web page stored in a Web server connected to Internet 7 is selected. A more specific description will be given below.

MFP 100A according to the first modification stores in EEPROM 115 a server correspondence table in which the first type of user agents and the second type of user agents are correlated in correspondence to each of one or more web pages stored in a Web server connected to Internet 7. The server correspondence table includes a server correspondence record which associates one of a plurality of the first type of user agents and one of a plurality of the second type of user agents with a URL assigned to a web page for each web page. A manufacturer of MFP 100 may have the server correspondence table stored in EEPROM 115 in advance, or a user of MFP 100 may register a correspondence record.

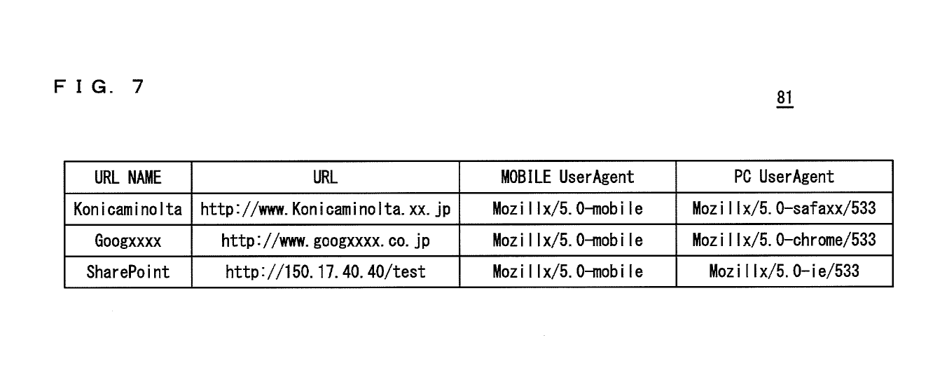

FIG. 7 is a diagram showing one example of a server correspondence table. With reference to FIG. 7, a server correspondence table 81 includes a server correspondence record which associates one of the first type of user agents with one of the second type of user agents respectively for each URL. More specifically, server correspondence table 81 includes an item of a URL name, an item of the URL, an item of the first type of user agent, and an item of the second type of user agent. In the item of the URL name, a name of a web page is set. In the item of the URL, the URL assigned to the web page is set.

In the item of the first type of user agent, one of the first type of user agents is set. In the item of the second type of user agent, one of the second type of user agents is set. The first type of user agents are a group of user agents determined by the set of the type and the version of the operating systems installed in PCs. The second type of user agents are a group of user agents determined by the set of the type and the version of the operating systems installed in portable computers.

MFP 100A according to the first modification has a similar function as the function shown in FIG. 4 except for agent selecting portion 59. In agent selecting portion 59 of MFP 100A according to the first modification, a URL is inputted from operation accepting portion 51, a property is inputted from property detection portion 71, a display capability is inputted from display capability detection portion 73, and a storage capacity is inputted from storage capacity detection portion 75. In response to the input of the URL from operation accepting portion 51, agent selecting portion 59 refers to server correspondence table 81 stored in EEPROM 115 and obtains the server correspondence record including the URL.

When a property is inputted from property detection portion 71, agent selecting portion 59 according to the first modification selects the type of user agent corresponding to the property from among the first type of user agents and the second type of user agents included in the server correspondence record extracted from server correspondence table 81 regardless of the display capability inputted from display capability detection portion 73 and the storage capacity inputted from storage capacity detection portion 75. More specifically, agent selecting portion 59 selects the first type of user agent included in the server correspondence record if the property inputted from property detection portion 71 indicates a personal computer, and selects the second type of user agent included in the server correspondence record if the property inputted from property detection portion 71 indicates a portable information device.

In the case where no property is inputted from property detection portion 71, in other words, when a user operates operation panel 160, agent selecting portion 59 according to the first modification selects one type of user agent from the first type of user agent and the second type of user agent according to the display capability inputted from display capability detection portion 73 and/or the storage capacity inputted from storage capacity detection portion 75. The operation in this case is the same as that of agent selecting portion 59 according to the embodiment described above so that the description will not be repeated here.

[Second Modification]

In MFP 100 according to the embodiment described above, the property is to be either one of a personal computer and a portable information device. A MFP 100B according to the second modification differs from MFP 100 described above in that the property is set to be the type and the version of an operating system installed in a device.

MFP 100B according to the second modification stores a plurality of a first type of user agents and a plurality of a second type of user agents respectively and stores in EEPROM 115 a device correspondence table which associates each of the plurality of a first type of user agents and the plurality of a second type of user agents with types and versions of operation systems. The device correspondence table includes a first device correspondence record which correlates a set of a type and a version of an operating system of a personal computer to each of the plurality of the first type of user agents and a second device correspondence record which correlates a set of a type and a version of an operating system of a portable information device to each of the plurality of the second type of user agents.

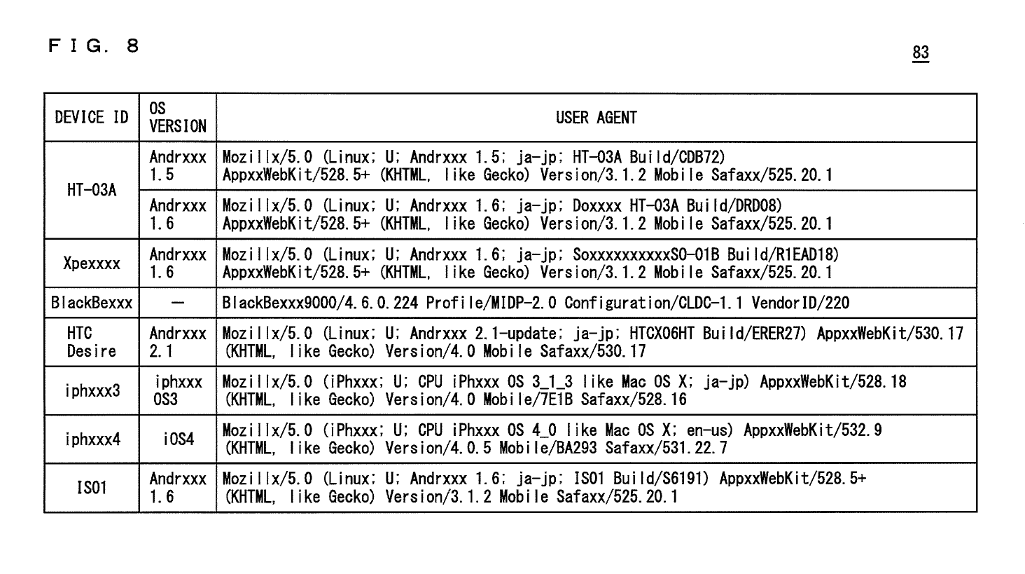

FIG. 8 is a diagram showing one example of a device correspondence table. With reference to FIG. 8, a device correspondence table 83 includes a device correspondence record which associates either one of the first type of user agent and the second type of user agent for each type and version of an operating system. More specifically, the device correspondence record includes an item of a device ID, an item of an OS version, and an item of a user agent. In the item of the device ID, information for identifying the type of the device is set. In the item of the OS version, the type and the version of the operating system are set.

In the item of the user agent, one of the first type of user agents or one of the second type of user agents is set. The first type of user agents are a group of user agents determined by the set of the type and the version of the operating systems installed in PCs. The second type of user agents are a group of user agents determined by the set of the type and the version of the operating systems installed in portable computers. A manufacturer of MFP 100B may have device correspondence table 83 stored in EEPROM 115 in advance, or a user of MFP 100B may register a correspondence record.

MFP 100B according to the second modification has a similar function as the function shown in FIG. 4 except for property detection portion 71 and agent selecting portion 59. In response to device identification information being inputted from operation accepting portion 51, property detection portion 71 according to the second modification detects the property of the device specified by the device identification information. The property includes the type and the version of the operating system installed in the device. More specifically, property detection portion 71 according to the second modification makes an inquiry to the device specified by the device identification information via communication I/F portion 112 so as to obtain the type and the version of the operating system.

In agent selecting portion 59 of MFP 100B according to the second modification, a property is inputted from property detection portion 71, a display capability is inputted from display capability detection portion 73, and a storage capacity is inputted from storage capacity detection portion 75.

When a property is inputted from property detection portion 71, agent selecting portion 59 according to the second modification refers to device correspondence table 83 stored in EEPROM 115 and extracts a device correspondence record including the type and the version of the operation system which are the same as those in the property inputted from property detection portion 71 regardless of the display capability inputted from display capability detection portion 73 and the storage capacity inputted from storage capacity detection portion 75, and then selects one of the first type of user agents or one of the second type of user agents determined by the extracted device correspondence record.

The operation of agent selecting portion 59 according to the second modification in the case where no property is inputted from property detection portion 71, in other words, when a user operates operation panel 160, is the same as the operation that is executed by agent selecting portion 59 of MFP 100 according to the above-described embodiment in the case where the user operates operation panel 160. Thus, the description will not be repeated here.

[Third Modification]

In MFP 100B according to the second modification, the property is to be the type and the version of an operating system installed in a device. A MFP 100C according to the third modification differs from MFP 100B according to the second modification in that the property is set to be the type and the version of a browsing program installed in the device. MFP 100C according to the third modification will be described below with main focus on where it differs from MFP 100B according to the second modification.

MFP 100C according to the third modification stores in EEPROM 115 a browser correspondence table which associates each of a plurality of a first type of user agents and a plurality of a second type of user agents with types and versions of browsing programs. The browser correspondence table includes a first browser correspondence record which correlates each of the plurality of the first type of user agents to a set of a type and a version of a browsing program that can be installed in a personal computer and a second browser correspondence record which correlates each of the plurality of the second type of user agents to a set of a type and a version of a browsing program that can be installed in a portable information device.

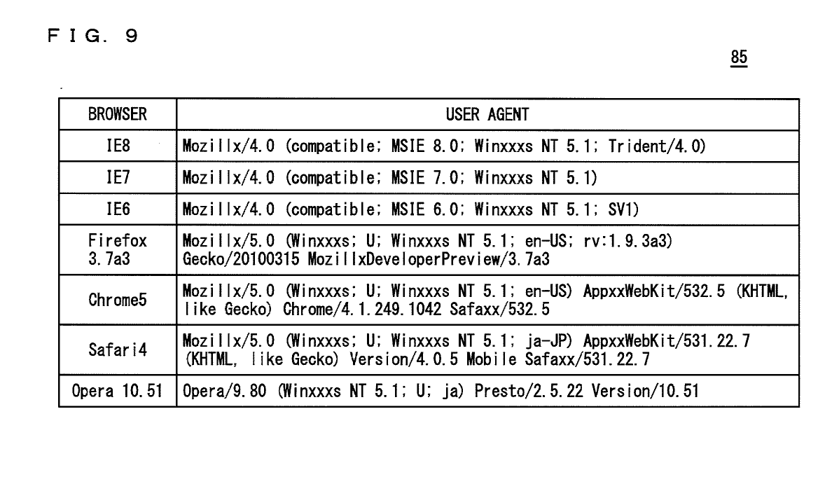

FIG. 9 is a diagram showing one example of a browser correspondence table. With reference to FIG. 9, a browser correspondence table 85 includes a browser correspondence record which associates either one of the first type of user agent and the second type of user agent for each type and version of a browsing program. More specifically, browser correspondence table 85 includes an item of a browser and an item of a user agent. In the item of the browser, the type and the version of the browsing program are set.

MFP 100C according to the third modification has a similar function as the function shown in FIG. 4 except for property detection portion 71 and agent selecting portion 59. In response to device identification information being inputted from operation accepting portion 51, property detection portion 71 according to the third modification detects the property of the device specified by the device identification information. The property includes the type and the version of the browsing program installed in the device. More specifically, property detection portion 71 according to the third modification makes an inquiry to the device specified by the device identification information via communication I/F portion 112 so as to obtain the type and the version of the browsing program.

In agent selecting portion 59 of MFP 100C according to the third modification, a property is inputted from property detection portion 71, a display capability is inputted from display capability detection portion 73, and a storage capacity is inputted from storage capacity detection portion 75.

When a property is inputted from property detection portion 71, agent selecting portion 59 according to the third modification refers to browser correspondence table 85 stored in EEPROM 115 and extracts a browser correspondence record including the type and the version of the browsing program which are the same as those in the property inputted from property detection portion 71 regardless of the display capability inputted from display capability detection portion 73 and the storage capacity inputted from storage capacity detection portion 75, and then selects one of the first type of user agents or one of the second type of user agents determined by the extracted browser correspondence record.

The operation of agent selecting portion 59 according to the third modification in the case where no property is inputted from property detection portion 71, in other words, when a user operates operation panel 160, is the same as the operation that is executed by agent selecting portion 59 of MFP 100 according to the above-described embodiment in the case where the user operates operation panel 160. Thus, the description will not be repeated here.

[Fourth Modification]

In MFP 100 according to the embodiment described above, the property is to be either one of a personal computer and a portable information device. A MFP 100D according to the fourth modification differs from MFP 100 described above in that the property is set to be the display capability of a device. The display capability of a device includes the resolution and the size of a screen that can be displayed.

MFP 100D according to the fourth modification has a similar function as the function shown in FIG. 4 except for property detection portion 71 and agent selecting portion 59. In response to device identification information being inputted from operation accepting portion 51, property detection portion 71 according to the fourth modification detects the display capability as the property of the device specified by the device identification information. More specifically, property detection portion 71 according to the fourth modification makes an inquiry to the device specified by the device identification information via communication I/F portion 112 so as to obtain the display capability.

In agent selecting portion 59 of MFP 100D according to the fourth modification, the display capability as a property is inputted from property detection portion 71, a display capability is inputted from display capability detection portion 73, and a storage capacity is inputted from storage capacity detection portion 75. The operation in the case where the property is inputted from property detection portion 71 into agent selecting portion 59 according to the fourth modification is the same as the operation executed by agent selecting portion 59 of MFP 100 according to the above-described embodiment in the case where the display capability is inputted from display capability detection portion 73. Thus, the description will not be repeated here.

The operation of agent selecting portion 59 according to the fourth modification in the case where no property is inputted from property detection portion 71, in other words, when a user operates operation panel 160, is the same as the operation that is executed by agent selecting portion 59 of MFP 100 according to the above-described embodiment in the case where the user operates operation panel 160. Thus, the description will not be repeated here.

[Fifth Modification]

While in MFP 100D according to the fourth modification, the property is to be the display capability of a device, a MFP 100E according to the fifth modification differs from MFP 100D according to the fourth modification in that the property is set to be a display capability of the device and, additionally, a storage capacity of the device.

MFP 100E according to the fifth modification has a similar function as the function shown in FIG. 4 except for property detection portion 71 and agent selecting portion 59. In response to device identification information being inputted from operation accepting portion 51, property detection portion 71 according to the fifth modification detects a display capability and a storage capacity as the property of the device specified by the device identification information. More specifically, property detection portion 71 according to the fifth modification makes an inquiry to the device specified by the device identification information via communication I/F portion 112 so as to obtain the display capability and the storage capacity.

In agent selecting portion 59 of MFP 100E according to the fifth modification, a display capability and a storage capacity as the property is inputted from property detection portion 71, a display capability is inputted from display capability detection portion 73, and a storage capacity is inputted from storage capacity detection portion 75. The operation in the case where the display capability and the storage capacity as the property is inputted from property detection portion 71 into agent selecting portion 59 according to the fifth modification is the same as the operation executed by agent selecting portion 59 of MFP 100 according to the above-described embodiment in the case where the display capability is inputted from display capability detection portion 73 and the storage capacity is inputted from storage capacity detection portion 75. Thus, the description will not be repeated here.

The operation of agent selecting portion 59 according to the fifth modification in the case where no property is inputted from property detection portion 71, in other words, when a user operates operation panel 160, is the same as the operation that is executed by agent selecting portion 59 of MFP 100 according to the above-described embodiment in the case where the user operates operation panel 160. Thus, the description will not be repeated here.

As described above, MFP 100 according to the present embodiment functions as an image forming device, stores a first type of user agent and a second type of user agent in advance, detects the display capability of display portion 161 and a free space of RAM 114 as a state of the device, selects a user agent of the type corresponding to the state of the device from the first type of user agent and the second type of user agent, and transmits to server 400 a page transmission request in which the selected user agent is set. As a result, the user agent can be altered according to the state of MFP 100. Moreover, the page transmission request is transmitted in which the user agent suited to the state of MFP 100 is set so that, even when the state of MFP 100 changes as a result of an optional equipment being provided additionally and so on, the transmission of a page suited for the state after the change can be requested to the server.

In addition, when operated by remote control by portable information device 200, PCs 300 or 300A, MFP 100 detects the free space of a RAM and the display capability of an external device at the origin of the remote control operation of portable information device 200, PCs 300 or 300A as a state of the external device, selects a user agent of the type corresponding to the state of the external device from the first type of user agent and the second type of user agent, and transmits to server 400 a page transmission request in which the selected user agent is set. As a result, the user agent can be altered according to the state of the external device at the origin of the remote control operation when MFP 100 is being operated by remote control. Moreover, the page transmission request is transmitted in which the user agent suited to the state of the external device at the origin of the remote control operation is set so that the transmission of the web page suited for the external device at the origin of the remote control operation can be requested to the server.

In addition, a first type of user agent is selected provided that the display capability of display portion 161 is a first threshold value TH1 or greater, and a second type of user agent is selected if the display capability is not equal to or greater than the first threshold value TH1. Consequently, the transmission of the page corresponding to the display capability can be requested to the server.

Moreover, in the case where another RAM besides RAM 114 is additionally provided, a first type of user agent is selected provided that the sum total of the storage capacity of RAM 114 and the storage capacity of the additionally provided RAM is a second threshold value TH2 or greater, and a second type of user agent is selected if the sum total is less than the second threshold value TH2. As a result, the transmission of the page corresponding to the storage capacity that can be used as a work area by CPU 111 can be requested to the server.

In addition, the display capability of display portion 161 and the storage capacity that can be used as a work area by CPU 111 are detected, and a first type of user agent is selected provided that the display capability is first threshold value TH1 or greater and that the storage capacity that can be used by CPU 111 is second threshold value TH2 or greater, and a second type of user agent is selected if the display capability is not equal to or greater than first threshold value TH1 or if the storage capacity is not equal to or greater than second threshold value TH2. Consequently, the transmission of the page corresponding to the display capability and the storage capacity that can be used by a CPU can be requested to the server.

The storage capacity that can be used as a work area by CPU 111 is to be a free space where data can be stored so that the transmission of the page corresponding to the circumstance of the use of RAM 114 can be requested to the server.

Furthermore, although MFP 100 is described as one example of an image forming device in the above-described embodiment, it goes without saying that the present invention can be construed as a web page obtaining method to cause MFP 100 to execute the web page obtaining process shown in FIGS. 5 and 6, and as a web page obtaining program to cause CPU 111 provided in MFP 100 to execute that web page obtaining method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image forming device, comprising:
a display portion to display an image;
a request portion to transmit a page transmission request in order to request transmission of a page described in a markup language from a server;
a rendering portion to interpret a page received from said server in response to the transmission of said page transmission request to generate a screen and to display the generated screen on said display portion;
a state detection portion to detect a state of the device; and
an agent selecting portion to select a user agent of a type corresponding to the state detected by said state detection portion from a first type of user agent and a second type of user agent; wherein
said request portion includes a setting portion to set said user agent selected in said page transmission request.

2. The image forming device according to claim 1, wherein
said state detection portion includes a display capability detection portion to detect a display capability of said display portion, and
said agent selecting portion selects the first type of user agent provided that said display capability detected is equal to or greater than a first threshold value and selects the second type of user agent if said display capability detected is less than the first threshold value.

3. The image forming device according to claim 2, wherein said display capability indicates at least one of size and resolution of said display portion.

4. The image forming device according to claim 1, further comprising a memory to store data in a volatile manner, wherein
said state detection portion includes a storage capacity detection portion to detect a storage capacity of said memory, and
said agent selecting portion selects said first type of user agent provided that said storage capacity detected is equal to or greater than a second threshold value and selects said second type of user agent if said storage capacity detected is less than the second threshold value.

5. The image forming device according to claim 4, wherein said storage capacity detection portion detects a free space where data can be stored in said memory.

6. The image forming device according to claim 1, further comprising a memory to store data in a volatile manner, wherein
said state detection portion includes
a storage capacity detection portion to detect a storage capacity of said memory, and
a display capability detection portion to detect a display capability of said display portion, and wherein
said agent selecting portion selects said first type of user agent provided that said display capability detected is equal to or greater than a first threshold value and that said storage capacity detected is equal to or greater than a second threshold value, and selects said second type of user agent if said display capability detected is less than the first threshold value or if said storage capacity detected is less than the second threshold value.

7. The image forming device according to claim 6, wherein said storage capacity detection portion detects a free space where data can be stored in said memory.

8. The image forming device according to claim 1, wherein
said request portion, when receiving a remote control operation from an external device connected to outside, transmits said page transmission request according to the remote control operation received, wherein
said rendering portion further includes a transmission portion to transmit to said external device a screen generated by interpreting a page transmitted from said server in response to the transmission of said page transmission request, when said request portion transmits said page transmission request according to the remote control operation received from said external device, wherein
said state detection portion includes a property detection portion to detect a property of said external device, and wherein
said agent selecting portion selects said first type of user agent if said property detected is a first property and selects said second type of user agent if said property detected is a second property.

9. The image forming device according to claim 1, wherein said first type of user agent includes a user agent given to a personal computer which is said first property, and
said second type of user agent includes a user agent given to a portable information equipment which is said second property.

10. A web page obtaining method executed in an image forming device provided with a display portion to display an image, comprising:
a requesting step to transmit a page transmission request in order to request transmission of a page described in a markup language from a server;
a rendering step to interpret a page received from said server in response to the transmission of said page transmission request to generate a screen and to display the generated screen on said display portion;
a state detecting step to detect a state of the device; and
an agent selecting step to select a user agent of a type corresponding to the state detected in said state detecting step from a first type of user agent and a second type of user agent; wherein
said requesting step includes a setting step to set said user agent selected in said page transmission request.

11. The web page obtaining method according to claim 10, wherein
said state detecting step includes a display capability detecting step to detect a display capability of said display portion, and
said agent selecting step includes the steps of:
selecting the first type of user agent provided that said display capability detected is equal to or greater than a first threshold value, and
selecting the second type of user agent if said display capability detected is less than the first threshold value.

12. The web page obtaining method according to claim 11, wherein said display capability indicates at least one of size and resolution of said display portion.

13. The web page obtaining method according to claim 10, wherein said image forming device further comprises a memory to store data in a volatile manner, and wherein
said state detecting step includes a storage capacity detecting step to detect a storage capacity of said memory, and
said agent selecting step includes the steps of:
selecting said first type of user agent provided that said storage capacity detected is equal to or greater than a second threshold value, and
selecting said second type of user agent if said storage capacity detected is less than the second threshold value.

14. The web page obtaining method according to claim 13, wherein said storage capacity detecting step includes detecting a free space where data can be stored in said memory.

15. The web page obtaining method according to claim 10, wherein said image forming device further comprises a memory to store data in a volatile manner, wherein
said state detecting step includes
a storage capacity detecting step to detect a storage capacity of said memory, and
a display capability detecting step to detect a display capability of said display portion, and wherein
said agent selecting step includes the steps of:
selecting said first type of user agent provided that said display capability detected is equal to or greater than a first threshold value and that said storage capacity detected is equal to or greater than a second threshold value, and
selecting said second type of user agent if said display capability detected is less than the first threshold value or if said storage capacity detected is less than the second threshold value.

16. The web page obtaining method according to claim 15, wherein said storage capacity detecting step includes detecting a free space where data can be stored in said memory.

17. The web page obtaining method according to claim 10, wherein
said requesting step, when a remote control operation is received from an external device connected to outside, includes transmitting said page transmission request according to the remote control operation received, wherein
said rendering step, when said page transmission request is transmitted according to the remote control operation received from said external device in said requesting step, further includes a transmitting step to transmit to said external device a screen generated by interpreting a page transmitted from said server in response to the transmission of said page transmission request, wherein
said state detecting step includes a property detecting step to detect a property of said external device, and wherein
said agent selecting step includes the steps of:
selecting said first type of user agent if said property detected is a first property, and
selecting said second type of user agent if said property detected is a second property.

18. The web page obtaining method according to claim 10, wherein said first type of user agent includes a user agent given to a personal computer which is said first property, and
said second type of user agent includes a user agent given to a portable information equipment which is said second property.

19. A non-transitory computer-readable recording medium encoded with a web page obtaining program executed by a computer, wherein said web page obtaining program executed by the computer controlling an image forming device provided with a display portion to display an image, causes said computer to execute
a requesting step to transmit a page transmission request in order to request transmission of a page described in a markup language from a server,
a rendering step to interpret a page received from said server in response to the transmission of said page transmission request to generate a screen and to display the generated screen on said display portion,
a state detecting step to detect a state of the device, and
an agent selecting step to select a user agent of a type corresponding to the state detected in said state detecting step from a first type of user agent and a second type of user agent, and wherein
said requesting step includes a setting step to set said user agent selected in said page transmission request.
